(19) United States
(12) Patent Application Publication
(10) Pub. No.: US 2025/0058661 A1
(43) Pub. Date: Feb. 20, 2025

(54) MULTI-LEVEL MULTI-FUNCTION INVERTER

(71) Applicant: GM Global Technology Operations LLC, Detroit, MI (US)

(72) Inventors: Chandra S. Namuduri, Troy, MI (US); Muhammad Hussain Alvi, Troy, MI (US); Rashmi Prasad, Troy, MI (US); Khorshed Mohammed Alam, Canton, MI (US); Junghoon Kim, Ann Arbor, MI (US); Yilun Luo, Ann Arbor, MI (US)

(21) Appl. No.: 18/449,997

(22) Filed: Aug. 15, 2023

(51) Int. Cl. B60L 53/22; B60L 50/60; H02M 7/483; H02M 7/5387; H02P 21/22; H02P 27/06

(52) U.S. Cl. CPC B60L 53/22; B60L 50/60; H02M 7/483; H02M 7/53871; H02P 21/22; H02P 27/06; B60L 2210/40

(57) ABSTRACT

A vehicle includes a system for charging a battery of the vehicle. An electric motor couples to a charging station. A T-bridge multi-level inverter couples the electric motor to the battery. The inverter includes a first leg having a first set of switches and a first AC terminal coupled to the electric motor, a second leg having a second set of switches and a second AC terminal coupled to the electric motor and a third leg having a third set of switches and a third AC terminal coupled to the electric motor. A processor connects the third AC terminal to the charging station and controls at least one of the first set of switches to control a first current through the first AC terminal of the first leg and the second set of switches to control a second current through second AC terminal of the second leg.

### INTRODUCTION

The subject disclosure relates to charging a battery of an electric vehicle and, in particular, to a method of operating switches of a multi-level inverter to control the charging operation.

Electric vehicles are being produced that have battery capacities that exceed the charging capacities of currently available charging stations. To support the backward compatibility of these electric vehicles, many have been equipped with additional on-board electronics in the form of a direct current (DC-DC) converter. However, such additional on-board electronics are undesirable because they increase the cost of the vehicle as well as its mass and volume. Accordingly, it is desirable to provide a method of charging the vehicle at currently available charging stations without the need for the additional on-board electronics to provide backward compatibility.

### SUMMARY

In one exemplary embodiment, a method of charging a battery of an electric vehicle is disclosed. A charging station is coupled to an electric motor of the vehicle, wherein the electric motor is coupled to the battery by a T-bridge multi-level inverter that includes a first leg having a first set of switches and a first AC terminal coupled to the electric motor, a second leg having a second set of switches and a second AC terminal coupled to the electric motor and a third leg having a third set of switches and a third AC terminal coupled to the electric motor. The third AC terminal of the third leg is connected to the charging station. At least one of the first set of switches to is controlled to control a first current through the first AC terminal of the first leg and the second set of switches is controlled to control a second current through the second AC terminal of the second leg to charge the battery via the charging station through the electric motor.

In addition to one or more of the features described herein, controlling the first current further includes controlling a first switching cycle for the first set of switches of the first leg and controlling the second current further includes controlling a second switching cycle for the second set of switches of the second leg.

In addition to one or more of the features described herein, the first leg includes a switch pair and switches of the switch pair receive inputs that are out of phase by 180 degrees.

In addition to one or more of the features described herein, the method further includes controlling a first magnitude of the first current and a second magnitude of the second current to generate a net zero torque at the electric motor for any angular location of a rotor of the motor.

In addition to one or more of the features described herein, the battery includes a first battery half-pack and a second battery half-pack, the method further includes opening a switch of the third leg to isolate one of the first battery half-pack and the second battery half-pack for individual charging.

In addition to one or more of the features described herein, the third leg includes a first pair of switches in series between a positive DC voltage bus and a negative DC voltage bus and a second pair of switches in series between the third AC terminal and neutral point, further includes performing one of placing all switches of the third leg in a closed configuration and closing the first pair of switches and opening the second pair of switches.

In addition to one or more of the features described herein, the method further includes connecting the second leg and the third leg to the charging station using switches that are operated to multiplex connections of the second leg and the third leg to the charging station.

In another exemplary embodiment, a system for charging a battery of a vehicle is disclosed. The system includes an electric motor, a T-bridge multi-level inverter and a processor. The electric motor is couplable to a charging station. The T-bridge multi-level inverter includes a first leg having a first set of switches and a first AC terminal coupled to the electric motor, a second leg having a second set of switches and a second AC terminal coupled to the electric motor and a third leg having a third set of switches and a third AC terminal couped to the electric motor, wherein the T-bridge multi-level inverter is configured to couple the electric motor to the battery. The processor is configured to connect the third AC terminal of the third leg to the charging station and control at least one of the first set of switches to control a first current through the first AC terminal of the first leg and the second set of switches to control a second current through second AC terminal of the second leg to charge the battery via the charging station through the electric motor.

In addition to one or more of the features described herein, the processor is further configured to control the first current by controlling a first switching cycle for the first set of switches of the first leg and to control the second current by controlling a second switching cycle for the first set of switches of the second leg.

In addition to one or more of the features described herein, the first leg includes a switch pair and the processor is further configured provide a carrier signal to the switch pair, wherein switches of the switch pair receive inputs that are out of phase by 180 degrees.

In addition to one or more of the features described herein, the processor is further configured to control a first magnitude of the first current and a second magnitude of the second current to generate a net zero torque at the electric motor for any angular location of a rotor of the motor.

In addition to one or more of the features described herein, the battery includes a first battery half-pack and a second battery half-pack and the processor is further configured to open a switch of the third leg to isolate one of the first battery half-pack and the second battery half-pack for individual charging.

In addition to one or more of the features described herein, the third leg includes a first pair of switches in series between a positive DC voltage bus and a negative DC voltage bus and a second pair of switches in series between the third AC terminal and neutral point and the processor is further configured to perform one of: (i) placing all switches of the third leg in a closed configuration; and (ii) closing the first pair of switches and opening the second pair of switches.

In addition to one or more of the features described herein, the processor is further configured to control a first connection between the second leg and the charging station and a second connection between the third leg and the charging station to multiplex operation of the first connection and the second connection.

In yet another exemplary embodiment, a vehicle is disclosed. The vehicle includes a battery, an electric motor, a T-bridge multi-level inverter and a processor. The electric motor is couplable to a charging station. The T-bridge multi-level inverter includes a first leg having a first set of switches and a first AC terminal coupled to the electric motor, a second leg having a second set of switches and a second AC terminal coupled to the electric motor and a third leg having a third set of switches and a third AC terminal coupled to the electric motor, wherein the T-bridge multi-level inverter is configured to couple the electric motor to the battery. The processor is configured to connect the third AC terminal of the third leg to the charging station and control at least one of the first set of switches to control a first current through the first AC terminal of the first leg and the second set of switches to control a second current through a second AC terminal the second leg to charge the battery via the charging station through the electric motor.

In addition to one or more of the features described herein, the processor is further configured to control the first current by controlling a first switching cycle for the first set of switches of the first leg and to control the second current by controlling a second switching cycle for the second set of switches of the second leg.

In addition to one or more of the features described herein, the first leg includes a switch pair and the processor is further configured provide a carrier signal to the switch pair, wherein switches of the switch pair receive complementary inputs.

In addition to one or more of the features described herein, the processor is further configured to control a first magnitude of the first current and a second magnitude of the second current to generate a net zero torque at the electric motor for any angular location of a rotor of the motor.

In addition to one or more of the features described herein, the battery includes a first battery half-pack and a second battery half-pack and the processor is further configured to open a switch of the third leg to isolate one of the first battery half-pack and the second battery half-pack for individual charging.

In addition to one or more of the features described herein, the third leg includes a first pair of switches in series between a positive DC voltage bus and a negative DC voltage bus and a second pair of switches in series between the third AC terminal and neutral point and the processor is further configured to perform one of: (i) placing all switches of the third leg in a closed configuration; and (ii) closing the first pair of switches and opening the second pair of switches.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a charging circuit for charging the electric vehicle, in an embodiment;

FIG. 3 is a schematic diagram showing details of the electric motor and the inverter;

FIG. 4 is a schematic diagram showing the electric motor, the inverter, and an inverter control circuit;

FIG. 5 is a schematic diagram showing details for charging a selected battery in an embodiment;

FIG. 6 shows a phase diagram of the electric motor, in an embodiment;

FIG. 7 shows a phase diagram of the electric motor in another embodiment;

FIG. 8 shows a phase diagram of the electric motor in another embodiment;

FIG. 9 is diagram showing the inverter in a configuration for charging a single battery half-pack; and

FIG. 10 shows the inverter in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

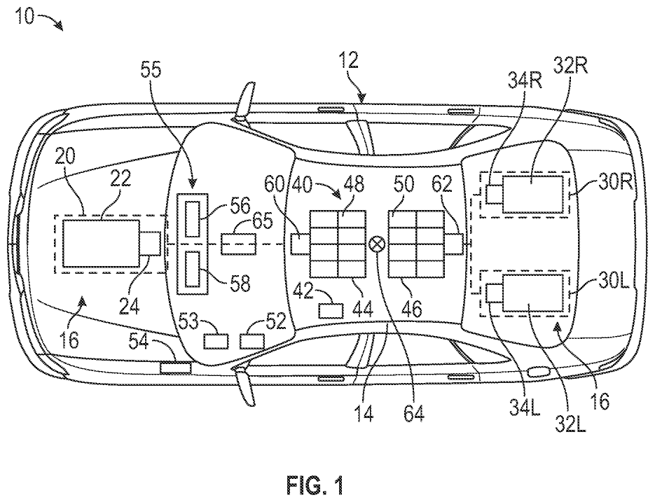

In accordance with an exemplary embodiment, FIG. 1 shows a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes an electric motor 32L and an inverter 34L. A right rear drive unit 30R includes an electric motor 32R and an inverter 34R. The inverters 24, 34L and 34R (e.g., power inverter units or PIMs) each convert DC power from a high voltage (HV) battery system 40 to poly-phase (e.g., two-phase, three-phase, six-phase, etc.) alternating current (AC) power to drive the front electric motor 22 and rear electric motors 32L and 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives front wheels (not shown) and the rear electric motors 32L and 32R drive rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

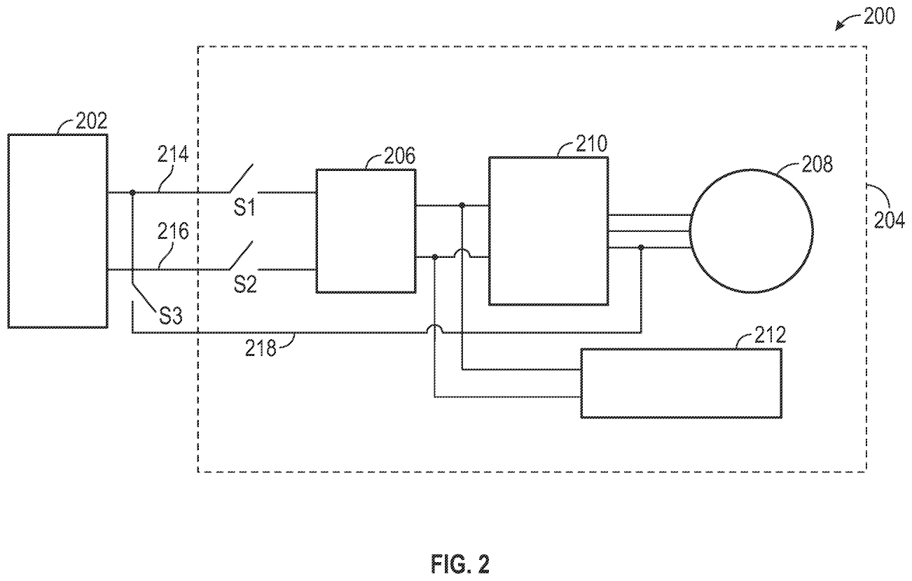

In an embodiment, the battery system 40 includes a plurality of separate battery assemblies, in which each battery assembly can be independently charged and can be used to independently supply power to a drive system or systems. For example, the battery system 40 includes a first battery assembly such as a first battery sub-pack 44 connected to the front inverter 24, and a second battery sub-pack 46. The first battery sub-pack 44 includes a plurality of battery modules 48, and the second battery sub-pack 46 includes a plurality of battery modules 50. Each battery module 48, 50 includes a number of individual cells (not shown). In various embodiments, one or more of the battery packs can include a MODACS (Multiple Output Dynamically Adjustable Capacity) battery, as described herein with respect to FIGS. 2-4.

Each of the front electric motor 22 and the rear electric motors 32L and 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the battery packs 44 and 46, and selectively connecting the battery packs 44 and 46 to the front drive unit 20, left rear drive unit 30L and right rear drive unit 30R. The switching devices may also be operated to selectively connect the first battery sub-pack 44 and the second battery sub-pack 46 to a charging system. The charging system can be used to charge the first battery sub-pack 44 and the second battery sub-pack 46, and/or to supply power from the first battery sub-pack 44 and/or the second battery sub-pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC). As shown in FIG. 1, the utility AC power supply is a charging station 110 that is connected to the charge port 54 via an electric cord 112.

In an embodiment, the switching system includes a first switching device 60 that selectively connects the first battery sub-pack 44 to the inverters 24, 34L and 34R, and a second switching device 62 that selectively connects the second battery sub-pack 46 to the inverters 24, 34L and 34R. The switching system also includes a third switching device 64 (also referred to as a “battery switching device”) for selectively connecting the first battery sub-pack 44 to the second battery sub-pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more softw are or firmw are programs, a combinational logic circuit, and/or other suitable components that provide the described functionality. The controller 65 may include a non-transitory computer-readable medium that stores instructions which, when processed by one or more processors of the controller 65, implement a method of charging a battery, according to one or more embodiments detailed herein. Such method includes operating various control blocks and switches of the vehicle, as discussed herein.

FIG. 2 shows a charging circuit 200 for charging the electric vehicle 10 in an embodiment. The charging circuit 200 shows the charging station 202 and vehicle electronics 204. The vehicle electronics 204 includes a battery pack 206 or power source, an electric motor 208 and an inverter 210 that couples the battery pack to the electric motor and converts direct current (DC) power from the battery pack into alternating current (AC) power for use at the electric motor. In various embodiments, the battery pack 206 is a single battery pack or multiple battery half-packs having a total voltage capacity of +800 Volts. The inverter 210 is a T-bridge multi-level inverter that includes a leg for each phase winding of the electric motor 208. In various embodiments, the electric motor 208 is a three-phase motor with three phase windings. Thus, the inverter 210 includes three legs. The vehicle electronics 204 further includes accessory loads 212, which generally have +800V power capacities and which are connected directly to the battery pack 206.

The battery pack 206 can be connected to the charging station 202 by a positive DCFC bus 214 and a negative DCFC bus 216. Positive DCFC bus 214 includes a first switch S1 and negative DCFC bus 216 includes a second switch S2, which are placed in an open configuration to disconnect from the charging station and in a closed configuration to connect to the charging station 202. A bypass line 218 connects from the positive DCFC bus 214 to a phase winding of the electric motor 208, thus providing a second channel for charging the battery pack 206. A bypass switch S3 on the bypass line 218 can be placed in a closed position to selectively implement of the second channel.

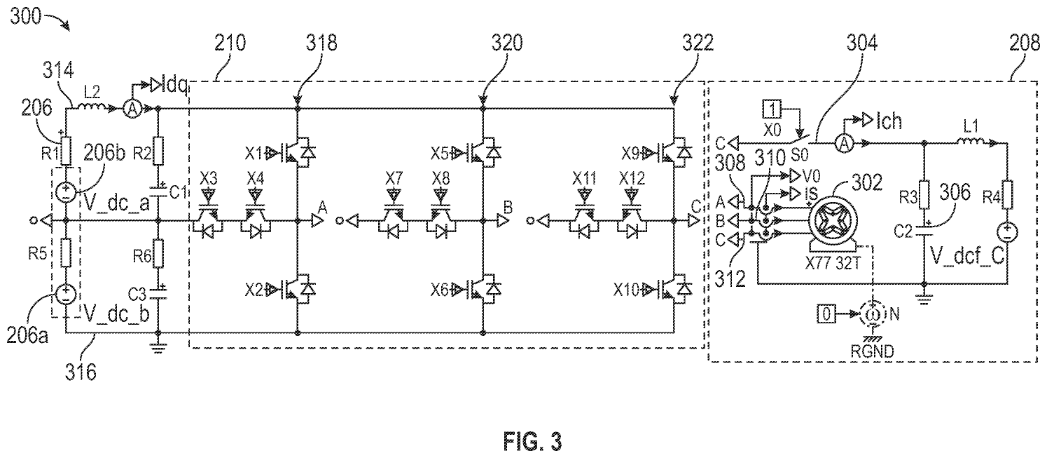

FIG. 3 is a schematic diagram 300 showing details of the electric motor 208 and the inverter 210. The electric motor 208 includes a rotor with a first phase winding 308 (labelled “A”), second phase winding 310 (labelled “B”) and third phase winding 312 (labelled “C”). The electric motor 208 connects to the charging station 202 through charging bus 304. A filter capacitor 306 controls a voltage level at the electric motor 302 by preventing or reducing spikes in the charging voltage.

The inverter 210 is connected to the battery pack 206 via a positive DC voltage bus 314 and a negative DC voltage bus 316. The battery pack 206 includes a first battery half-pack 206a and a second battery half-pack 206b connected in series with a neutral point O between the first battery and the second battery.

The inverter 210 includes a first leg 318, a second leg 320 and a third leg 322, each of which extends between the positive DC voltage bus 314 and the negative DC voltage bus 316. Each leg includes four switches arranged in a T-configuration. For example, the first leg 318 includes switches X1, X2, X3 and X4. Switches X1 and X2 are in series between the positive DC voltage bus 314 and the negative DC voltage bus 316. The first phase winding 308 of the electric motor 302 connects to a first AC terminal (labelled “A”) of the first leg 318 between the first switch X1 and the second switch X2. Switches X3 and X4 are in series between the first AC terminal and the neutral point O of the battery pack 206. Similarly, the second leg 320 includes switches X5, X6. X7 and X8, in the T-configuration. Switches X5 and X6 are in series between the positive DC voltage bus 314 and the negative DC voltage bus 316. The second phase winding 310 of the electric motor 302 connects to a second AC terminal (labelled “B”) of the second leg 320 between the switch X5 and the switch X6. Switches X7 and X8 are in series between the second AC terminal and the neutral point O of the battery pack 206. Also, the third leg 322 includes switches X9, X10, X11 and X12 in the T-configuration. Switches X9 and X10 are in series between the positive DC voltage bus 314 and the negative DC voltage bus 316. The third phase winding 312 of the electric motor 302 connects to a third AC terminal (labelled “C”) of the third leg 322 between the switch X9 and the switch X10. Switches X11 and X12 are in series between the third AC terminal and the neutral point O of the battery pack 206.

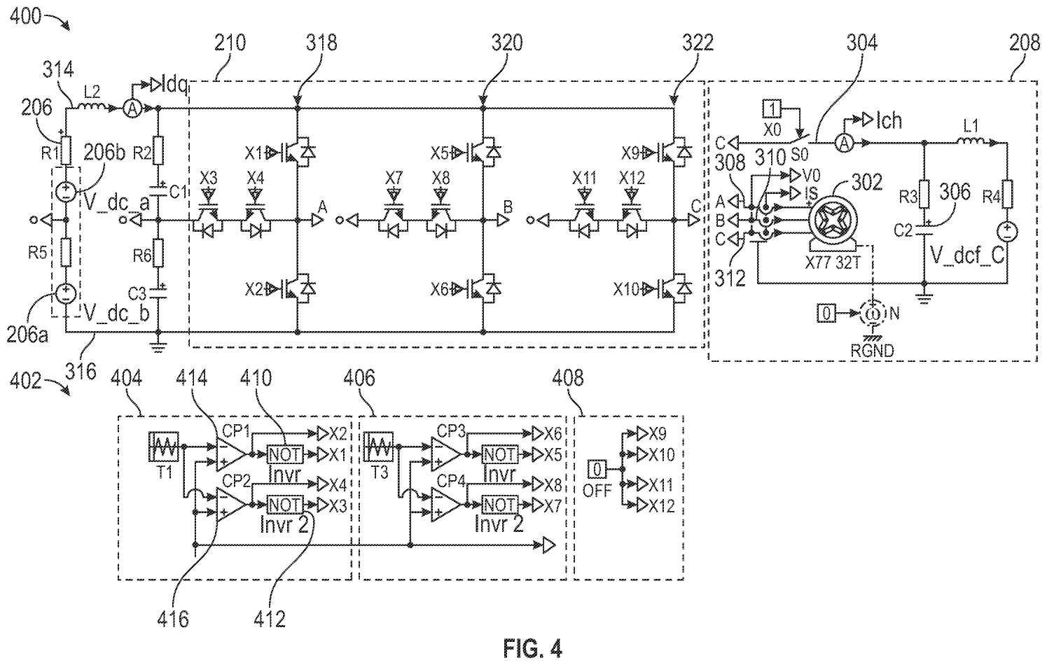

FIG. 4 is a schematic diagram 400 showing the electric motor 208, the inverter 210, and an inverter control circuit 402. The inverter control circuit 402 is used to control the flow of current through the legs of the inverter 210 during a charging scenario for the battery pack 206. The inverter control circuit 402 includes a first control block 404 for controlling the switches (X1, X2, X3, X4) of the first leg 318, a second control block 406 for controlling the switches (X5, X6, X7, X8) of the second leg 320, and a third control block 408 for controlling the switches (X9, X10, X11, X12) of the third leg 322.

The first control block 404 provides control signals to the switches (X1, X2, X3, X4) as grouped in switch pairs, namely, a first switch pair [X1, X2] and a second switch pair [X3, X4]. The first switch pair [X1, X2] is driven by complementary control inputs. For example, a logic inverter 410 at switch X1 ensures that switch X1 is off when X2 is on and that switch X1 is on when X2 is off. The second switch pair [X3, X4] operates similarly, with a logic inverter 410 at the third switch X3. A first comparator 412 receives a first carrier signal T1 and a duty cycle signal and provides output that is sent to the first switch pair [X1, X2]. Similarly, a second comparator 414 receives the first carrier signal T1 and the duty cycle signal and provides output that is sent to the second switch pair [X3, X4]. The first carrier signal is 180 degrees shifted in phase from the second carrier signal. This results in switch pairs [X1, X2] and [X3, X4] being out of phase with each other by 180 degrees. In other words, switch X1 and switch X3 are out of phase with each other by 180 degrees within a switching cycle and switch X2 and switch X4 are out of phase with each other by 180 degrees within the switching cycle.

The second control block 406 operates similarly to the first control block 404, using a second carrier signal T3 that is used to control switch pairs [X5, X6] and [X7, X8]. The carrier signal T3 and the carrier signal T4 are phase-shifted with respect to each other by 180 degrees. In addition, the carrier signal T3 is phase-shifted by 180 degrees with respect to the carrier signal T1. In an embodiment, the duty cycle is a single duty cycle that is applied across the first control block 404 and the second control block 406. In another embodiment, the first control block 404 can receive a first duty cycle signal and the second control block 406 can receive a second duty cycle signal.

In a charging scenario, the third control block turns off the switches (X9, X10, X11, X12) of the third leg 322 and the charging station 110 is connected to the third AC terminal. The first control block 404 and the second control block 406 are used to control the flow of a first current through the first leg 318 and of a second current the second leg 320, respectively. In another embodiment, the first control block 404 turns off the switches (X1, X2, X3. X4) of the first leg 318 and the charging station 110 is connected to the first AC terminal. The second control block 406 and the third control block 408 control the flow of current through the second leg 320 and the third leg 322, respectively. In yet another embodiment, the second control block 406 turns off the switches (X5, X6, X7, X8) of the second leg 320 and the charging station 110 is connected to the second AC terminal. The first control block 404 and the third control block 408 control the flow of current through the first leg 318 and the third leg 322, respectively.

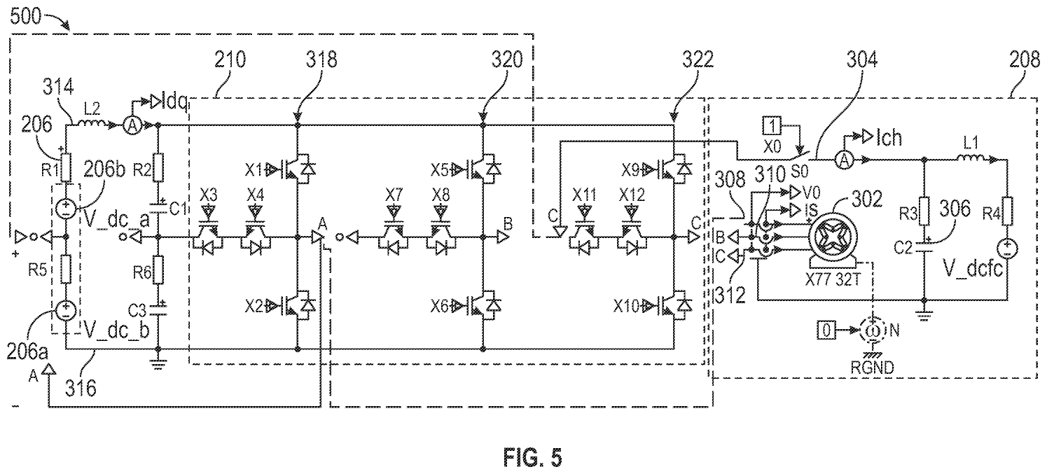

FIG. 5 is a schematic diagram 500 showing details for charging a selected battery (e.g., first battery half-pack 206a) in an embodiment. The third control block 408 configures the third leg 322 with switches X9 and X10 in an OFF position and switches X11 and X12 in an ON position. Thus, the charging bus 304 connects to the neutral point O via switches X11 and X12. The phase winding A 308 connects through first leg 318 (and switch X2) to the negative DC voltage bus 316. In this configuration, the charging station 202 is connected only to the first battery half-pack 206a. A similar configuration of switches can be used to connect the charging station to only the second battery half-pack 206b.

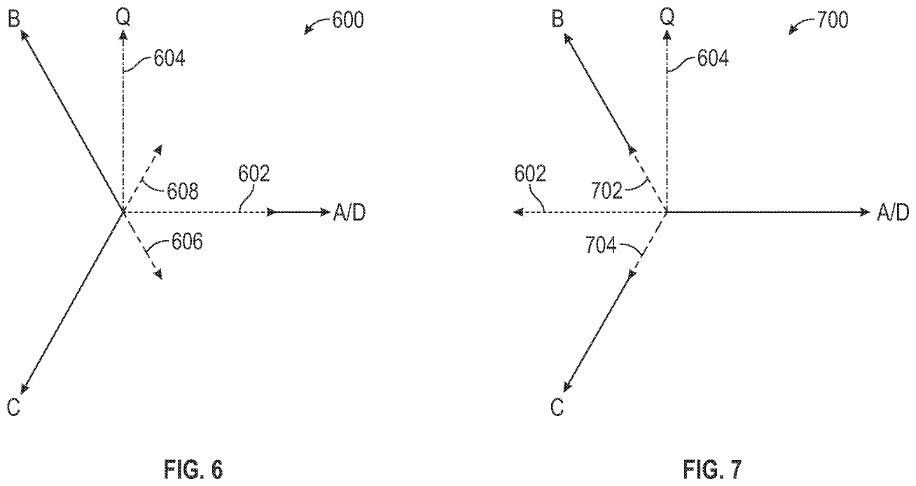

FIG. 6 shows a phase diagram 600 of the electric motor 302, in an embodiment. The phase diagram 600 includes a first phase branch A representing the current phase through the first phase winding 308, a second phase branch B representing the current phase through the second phase winding 310 and a third phase C representing the current phase through the third phase winding 312. Phases branches A, B and C are 120 degrees out of phase with each other. A direct ax is 602 (D) and quadrature ax is 604 (Q) of a rotor of the electric motor 302 are shown on the phase diagram 600. The direct ax is 602 is aligned along the first phase branch A for illustrative purposes. To ensure a net zero torque production or minimal torque production at the rotor, the current is controlled to create a net current vector along the D axis. This can be achieved, for example, by connecting the charging station to first phase winding 308 (aligned with +D axis) and then controlling the negative current (i.e., current from the charging station to the battery) to be equal in magnitude through the second phase winding B and third phase winding C. The current through the second phase winding B generates a first negative torque vector 606 and the current through the third phase winding C generates a second negative torque vector 608. The magnitude of the first negative torque vector 606 is equal to the magnitude of the second negative torque vector 608. Thus, the sum of these torque vectors lies along the direct ax is 602 (i.e., along the first phase branch A).

FIG. 7 shows a phase diagram 700 of the electric motor in another embodiment. The direct ax is 602 is aligned opposite the first phase branch A. Current is controlled through the second phase winding B to create a first positive torque vector 702. Current is also controlled through the third phase winding C to create a second positive torque vector 704. The sum of these torque vectors lies along the direct ax is 602 (lying anti-parallel to the first phase branch A).

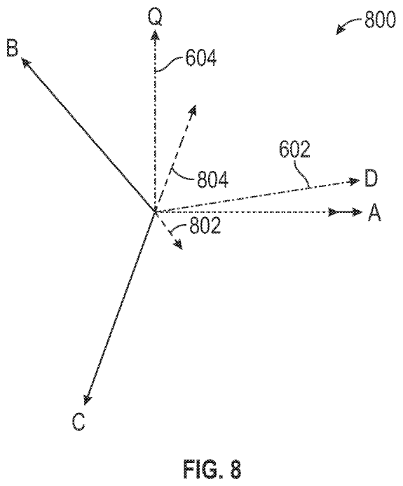

FIG. 8 shows a phase diagram 800 of the electric motor in another embodiment. The direct ax is 602 of the rotor is not aligned with the phase axes A. The current can be controlled to have different currents in the second phase winding B and the third phase winding C, resulting in a first torque vector 802 and a second torque vector 804 which have different magnitudes. The summation of these torque vectors results in the combined torque that is along the D axis. Thus, for any angular position of the D ax is of the rotor, an appropriate leg of the inverter can be turned off and the current through the remaining legs can be controlled appropriately to provide the required torque vector along the D axis.

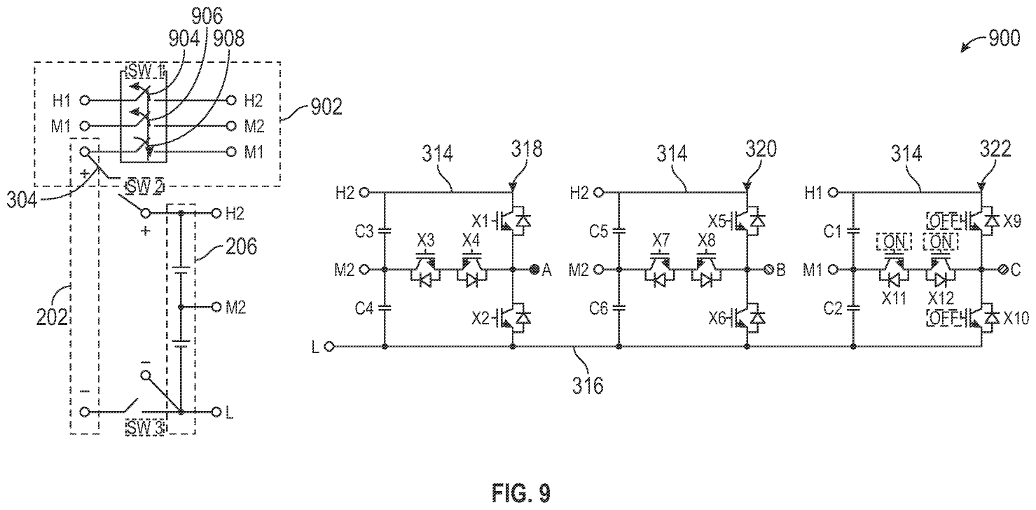

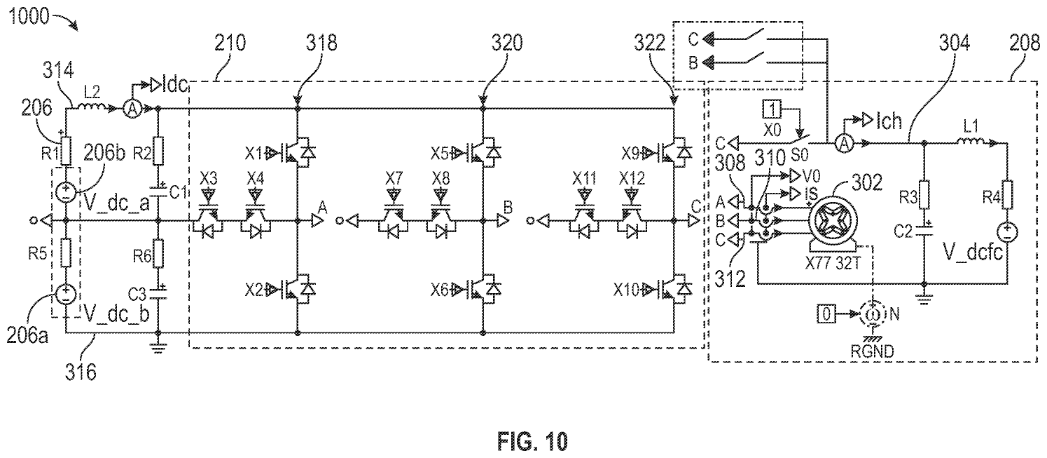

FIG. 9 is diagram 900 showing the inverter in a configuration for charging a single battery half-pack. The DCFC port is connected to the phase legs via a switch box 902 including a first DCFC switch 904, second DCFC switch 906, and a third DCFC switch 908. The first DCFC switch 904 connects the first leg 318 and second leg 320 to the third leg 322 across the positive DC voltage bus 314 (i.e., a connection between node H1 and node H2). The second DCFC switch 906 connects the first leg 318 and second leg 320 to the third leg 322 across the neutral points (i.e., a connection between node M1 and node M2). The third DCFC switch 908 connects the charging bus 304 to the neutral point via the third leg 322. In the configuration shown in FIG. 9 the first DCFC switch 904 is open (OFF), the second DCFC switch 906 is open (OFF), and the third DCFC switch 908 is closed (ON). Additionally, third leg 322 includes switches X9 and X10 which are placed in a closed (OFF) configuration and switches X11 and X12 which are placed in an open (ON) configuration. In this configuration, the C2 capacitor can be used as a +400V input DC capacitor (i.e., a filter capacitor for charging).

FIG. 10 shows the inverter 1000 in another embodiment. The charging bus 304 includes a first charging line 1002 connecting to the second phase winding 310 and a second charging line 1004 connecting to the third phase winding 312. The first charging line 1002 includes a first charging line switch 1006 and the second charging line 1004 includes a second charging line switch 1008. The first charging line switch 1006 and the second charging line switch 1008 can be operated to provide a multiplexed input phase, thereby minimizing the stresses on the motor during the charging procedure.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of charging a battery of an electric vehicle, comprising:
coupling a charging station to an electric motor of the vehicle, wherein the electric motor is coupled to the battery by a T-bridge multi-level inverter that includes a first leg having a first set of switches and a first AC terminal coupled to the electric motor, a second leg having a second set of switches and a second AC terminal coupled to the electric motor and a third leg having a third set of switches and a third AC terminal coupled to the electric motor;
connecting the third AC terminal of the third leg to the charging station; and
controlling at least one of the first set of switches to control a first current through the first AC terminal of the first leg and the second set of switches to control a second current through the second AC terminal of the second leg to charge the battery via the charging station through the electric motor.

2. The method of claim 1, wherein controlling the first current further comprises controlling a first switching cycle for the first set of switches of the first leg and controlling the second current further comprises controlling a second switching cycle for the second set of switches of the second leg.

3. The method of claim 2, wherein the first leg includes a switch pair and switches of the switch pair receive inputs that are out of phase by 180 degrees.

4. The method of claim 1, further comprising controlling a first magnitude of the first current and a second magnitude of the second current to generate a net zero torque at the electric motor for any angular location of a rotor of the motor.

5. The method of claim 1, wherein the battery includes a first battery half-pack and a second battery half-pack, the method further comprising opening a switch of the third leg to isolate one of the first battery half-pack and the second battery half-pack for individual charging.

6. The method of claim 1, wherein the third leg includes a first pair of switches in series between a positive DC voltage bus and a negative DC voltage bus and a second pair of switches in series between the third AC terminal and neutral point, further comprising performing one of: (i) placing all switches of the third leg in a closed configuration; and (ii) closing the first pair of switches and opening the second pair of switches.

7. The method of claim 1, further comprising connecting the second leg and the third leg to the charging station using switches that are operated to multiplex connections of the second leg and the third leg to the charging station.

8. A system for charging a battery of a vehicle, comprising:
an electric motor couplable to a charging station;
a T-bridge multi-level inverter that includes a first leg having a first set of switches and a first AC terminal coupled to the electric motor, a second leg having a second set of switches and a second AC terminal coupled to the electric motor and a third leg having a third set of switches and a third AC terminal couped to the electric motor, wherein the T-bridge multi-level inverter is configured to couple the electric motor to the battery;
processor configured to:
connect the third AC terminal of the third leg to the charging station; and
control at least one of the first set of switches to control a first current through the first AC terminal of the first leg and the second set of switches to control a second current through second AC terminal of the second leg to charge the battery via the charging station through the electric motor.

9. The system of claim 8, wherein the processor is further configured to control the first current by controlling a first switching cycle for the first set of switches of the first leg and to control the second current by controlling a second switching cycle for the first set of switches of the second leg.

10. The system of claim 9, wherein the first leg includes a switch pair and the processor is further configured provide a carrier signal to the switch pair, wherein switches of the switch pair receive inputs that are out of phase by 180 degrees.

11. The system of claim 8, wherein the processor is further configured to control a first magnitude of the first current and a second magnitude of the second current to generate a net zero torque at the electric motor for any angular location of a rotor of the motor.

12. The system of claim 8, wherein the battery includes a first battery half-pack and a second battery half-pack and the processor is further configured to open a switch of the third leg to isolate one of the first battery half-pack and the second battery half-pack for individual charging.

13. The system of claim 8, wherein the third leg includes a first pair of switches in series between a positive DC voltage bus and a negative DC voltage bus and a second pair of switches in series between the third AC terminal and neutral point and the processor is further configured to perform one of: (i) placing all switches of the third leg in a closed configuration; and (ii) closing the first pair of switches and opening the second pair of switches.

14. The system of claim 8, wherein the processor is further configured to control a first connection between the second leg and the charging station and a second connection between the third leg and the charging station to multiplex operation of the first connection and the second connection.

15. A vehicle, comprising:
a battery;
an electric motor couplable to a charging station;
a T-bridge multi-level inverter that includes a first leg having a first set of switches and a first AC terminal coupled to the electric motor, a second leg having a second set of switches and a second AC terminal coupled to the electric motor and a third leg having a third set of switches and a third AC terminal coupled to the electric motor, wherein the T-bridge multi-level inverter is configured to couple the electric motor to the battery;
processor configured to:
connect the third AC terminal of the third leg to the charging station; and
control at least one of the first set of switches to control a first current through the first AC terminal of the first leg and the second set of switches to control a second current through a second AC terminal the second leg to charge the battery via the charging station through the electric motor.

16. The vehicle of claim 15, wherein the processor is further configured to control the first current by controlling a first switching cycle for the first set of switches of the first leg and to control the second current by controlling a second switching cycle for the second set of switches of the second leg.

17. The vehicle of claim 16, wherein the first leg includes a switch pair and the processor is further configured provide a carrier signal to the switch pair, wherein switches of the switch pair receive complementary inputs.

18. The vehicle of claim 15, wherein the processor is further configured to control a first magnitude of the first current and a second magnitude of the second current to generate a net zero torque at the electric motor for any angular location of a rotor of the motor.

19. The vehicle of claim 15, wherein the battery includes a first battery half-pack and a second battery half-pack and the processor is further configured to open a switch of the third leg to isolate one of the first battery half-pack and the second battery half-pack for individual charging.

20. The vehicle of claim 15, wherein the third leg includes a first pair of switches in series between a positive DC voltage bus and a negative DC voltage bus and a second pair of switches in series between the third AC terminal and neutral point and the processor is further configured to perform one of: (i) placing all switches of the third leg in a closed configuration; and (ii) closing the first pair of switches and opening the second pair of switches.
